(19) United States
(12) Patent Application Publication
(10) Pub. No.: US 2006/0132445 A1
(43) Pub. Date: Jun. 22, 2006

(54) Input device

(75) Inventor: Josef Huttner, Regensburg (DE)

Correspondence Address: COHEN, PONTANI, LIEBERMAN & PAVANE, 551 FIFTH AVENUE, SUITE 1210, NEW YORK, NY, 10176, US

(73) Assignee: Osram Opto Semiconductors GmbH, Regensburg (DE)

(21) Appl. No.: 11/273,931

(22) Filed: Nov. 14, 2005

(30) Foreign Application Priority Data
Nov. 15, 2004 (DE) 10 2004 055 085.9
Nov. 10, 2005 (DE) 10 2005 053 766.9

(51) Int. Cl. G09G 5/00

(52) U.S. Cl. 345/168

(57) ABSTRACT

An input device having a first character of a first color, a second character of a second color and an illumination device which produces light of the first color and/or of the second color such that, depending on the illumination of the input device, in a first operating state only the first character of the first color, in a second operating state only the second character of the second color, or in a third operating state both characters appear.

### RELATED APPLICATIONS

This patent application claims the priority of German patent application no. 10 2004 055 085.9 filed Nov. 15, 2004, the disclosure content of which is hereby incorporated by reference.

### FIELD OF THE INVENTION

The invention relates to an input device. In this context, the input device may be a keypad, for example, which has at least one key.

### BACKGROUND OF THE INVENTION

Laid-open specification DE 102 45 629 A1 discloses an electronic appliance in which pressure-sensitive keys are illuminated by means of LEDs in a prescribed color.

Some applications may require the display of characters on an input device being changed on a contextual basis (contextual character display). In the case of a mobile telephone, for example, it is advantageous if only digits are displayed on the keypad in order to input a telephone number and only letters are displayed in order to input a text, for example an SMS (Short Message Service).

In conventional input devices, for example touchscreens, contextual character display is implemented by virtue of different keypads faded in for different contexts.

### SUMMARY OF THE INVENTION

It is an object of the present invention to provide a single input device with contextual character display.

This and other objects are attained in accordance with one aspect of the present invention directed to an input device having a first character of a first color, a second character of a second color and an illumination device which produces light of the first color and/or of the second color such that, depending on the illumination of the input device, in a first operating state only the first character of the first color and in the second operating state only the second character of the second color appears.

Within the context of the invention, a character is understood to mean a symbol in any shape or form which can be put as lettering on a medium, for example, or may be contained in the medium as a component part.

Preferably, the input device is a keypad, for example the keypad of a mobile telephone, and has a plurality of keys. Particularly preferably, each of the keys is provided with at least two different characters, which means that the overall size of the input device may advantageously be made small. This is because this measure means that it is not necessary to provide a key for each individual character. A small overall size for the input device is desirable in the case of a mobile telephone, for example, which needs to be particularly handy, that is to say small and lightweight.

In addition, user friendliness plays an important part for such an input device. In particular, the clarity of the character display on an input device for an appliance may significantly simplify operation of the appliance.

According to the invention, the clarity of the character display is assisted by virtue of the two characters on the key being in different colors from one another. For a user, the color difference between the two characters is helpful for clearly identifying the two different characters or for distinguishing the two characters, particularly when the two characters have two different control functions associated with them. By way of example, in a mobile telephone the first character may be a digit of a first color and the second character may be a letter of a second color (contextual character display).

Preferably, when the first character is displayed the appliance is put into a first operating state, where the user can see only the first character. Accordingly, when the second character is displayed the appliance is put into a second operating state, where the user can see only the second character.

In a third operating state, both characters are visible. Advantageously, ambient illumination is sufficient for the visibility of the two characters in the third operating state. In addition, the input device may be illuminated with light of mixed color which is produced by the illumination device. Preferably, the input device or the key is illuminated with white light.

In a first embodiment of the invention, the input device has at least one key, with the material of the key being permeable to light of the first and second colors. In this case, the key has a first character of the first color and a second character of the second color put, for example printed, on it.

If the key in a first operating state is illuminated by the illumination device with light of the second color, then the second character of the second color is embedded into a colored background from which its color does not stand out. It is thus hidden as a result of being embedded in a background of matching color. This embedding is also called a “camouflage effect”. By contrast, the first character, which has a first color, does stand out with its color from the background, and the first character therefore appears visibly to the user. Conversely, in the second operating state the second character appears visibly to the user when the input device is illuminated with light of the first color. This is because in that case the first character of the first color is embedded into the background of matching color. With ambient light or illumination with light of mixed color, preferably white light, both characters appear visibly to the user in the third operating state.

Within the context of the invention, a color match between the color of the character and that of the background is not intended to be understood to mean just exact equality of the wavelengths or spectral distributions, but rather also an identical or similar color impression which the user obtains.

In a second embodiment of the invention, the input device has at least one key which contains a nontranslucent material being impermeable to light. Preferably, the material is impermeable to light of the first and second colors. Particularly preferably, the key comprises a first character which is permeable to light of the first color and a second character which is permeable to light of the second color. If the key in the first operating state is illuminated by the illumination device with light of the first color then the user can see the first character clearly, while the second character remains dark and becomes less prominent. Accordingly, in the second operating state when the key is illuminated with light of the second color the user can see the second character clearly, while the first character remains dark and becomes less prominent. The key itself remains unchanged in terms of color.

The first character contains a material which is permeable to light of the first color, while it filters out light of the second color. A similar situation applies to the second character, which contains a material which filters out light of the first color. With ambient light or illumination with light of mixed color, preferably white light, the user can see both characters clearly in the third operating state.

Advantageously, the first color of the light produced by the illumination device matches the first color of the first character, and the second color of the light produced by the illumination device matches the second color of the second character. However, it is also conceivable for the color of the illumination and the color of the character to differ, but only to such an extent that the user is nonetheless able to make a clearly and readily discernible distinction between the first and second characters.

In the case of an input device for an appliance, the character used is preferably an alphanumeric symbol or an alphanumeric symbol sequence. It is also conceivable to have symbols with an indication of function, such as the symbol for a telephone receiver in the case of a mobile telephone. Advantageously, different symbols or symbol sequences can be made identifiable, according to the invention, by different colors. Particularly advantageously, a key of the input device is provided with a digit of the first color and with a letter of the second color (contextual character display), which makes it easier for the user to handle the appliance and its various functions.

The input device has an illumination device for illumination. The illumination device can be mounted between a top side and an underside of the appliance, with the input device being arranged on the top side such that it can be illuminated by the light emitted by the illumination device. The light can be injected into the key laterally and/or vertically from the illumination device.

In one embodiment, the appliance has a common illumination device for all the keys, with the light produced being guided to the individual keys on the keypad by an optical fiber. This arrangement with just one illumination device is inexpensive and also has a positive effect on the overall size of the electronic appliance, since space does not need to be provided for further illumination devices.

The illumination device can have a radiation-emitting semiconductor component, for example a light-emitting diode. To produce at least two-color light, the illumination device can have at least two components which produce light of two different wavelengths. Alternatively, the illumination device can have at least one component which comprises at least two semiconductor chips which produce light of two different wavelengths. The latter alternative affords the advantage of simpler manufacture, since only one light-emitting diode needs to be provided for an illumination device which produces light of different color. In addition, the component for producing multicolored light can have a semiconductor chip which has a conversion element, preferably a cast, arranged downstream of it in the direction of radiation for the purpose of wavelength conversion of the radiation produced.

In the case of an appliance with an input device based on the invention, the operating state which the user requires is preferably activated automatically. By way of example, with a mobile telephone the letters may then illuminate when the user calls the “write message” function. Alternatively, the user can set the required operating state manually.

An input device based on the invention can preferably be used for a mobile electronic appliance, for example for a mobile telephone, a Notebook, a PDA or an MP3 player.

Within the context of the invention, a color distinction between characters is preferably provided for contextual character display. However, there are also other conceivable options for distinguishing characters where the described camouflage effect works. For example, the camouflage effect could work if color pigments with a filtering effect were arranged not homogenously, but texture-like, according to a certain pattern.

### BRIEF DESCRIPTION OF THE DRAWINGS

FIG. 1 shows a schematic illustration of a key of an input device in the first operating state in line with a first exemplary embodiment of the invention.

FIG. 2 shows a schematic illustration of the key shown in FIG. 1 in the second operating state.

FIG. 3 shows a schematic illustration of the key shown in FIG. 1 in the third operating state.

FIG. 4 shows a schematic illustration of a key of an input device in the first operating state in line with a second exemplary embodiment of the invention.

FIG. 5 shows a schematic illustration of the key shown in FIG. 4 in the second operating state.

FIG. 6 shows a schematic illustration of the key shown in FIG. 4 in the third operating state.

FIG. 7a shows a schematic plan view of a mobile telephone with a third exemplary embodiment of an input device based on the invention.

FIG. 7b is a cross-sectional view taken along line A-A′ in FIG. 7a.

FIG. 7c is a cross-sectional view of a variation of the third embodiment, and taken along line A-A′ in FIG. 7a.

### DETAILED DESCRIPTION OF THE DRAWINGS

In the exemplary embodiments and figures, parts which are the same or have the same effect have respectively been provided with the same reference symbols.

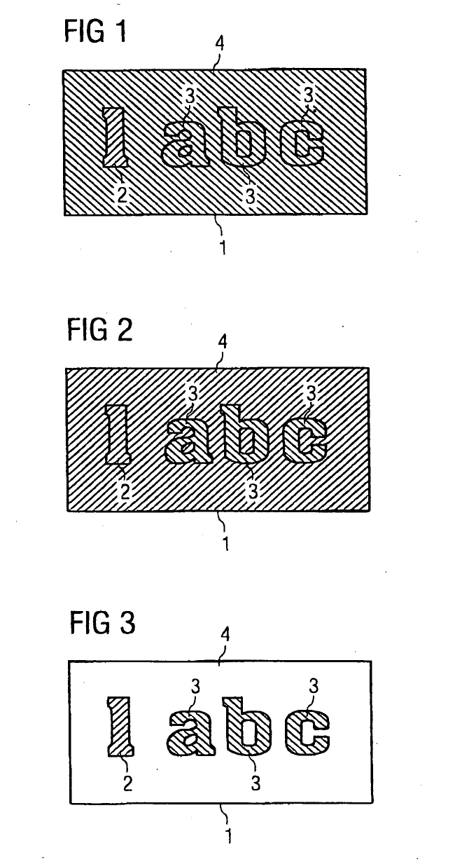

FIGS. 1 to 3 and 4 to 6 show a key 1 of an input device in three different operating states. The key 1 has a first character 2 which, by way of example, is a digit “1”, as shown, and a second character 3, the character 3 being a symbol sequence, for example comprising the three letters “abc”, as shown. The characters 2 and 3, for example, may be put directly on the key body 4, for example printed, or may be introduced, for example inserted, as dedicated component parts. In addition, the key body 4 and the characters 2 and 3 may be provided with a protective body which protects the characters 2 and 3, in particular, against mechanical abrasion or other damage which significantly impairs the discernability of the characters. By way of example, the protective body may cover the key body 4 and the characters 2 and 3 in the form of a transparent case. The key 1 comprises the characters 2 and 3, a key body 4 and possibly a protective body. The key 1 may be a component part of a keypad, as used on mobile telephones, for example.

FIG. 1 shows a schematic illustration of the first operating state of the key 1 in line with a first exemplary embodiment of the invention. In this case, the character 2 has a first color, which is illustrated by linear shading slopes up to the right. The character 3 has a second color, which is illustrated by linear shading which slopes up to the left.

As a result of being embedded in a background with the second color, which is correspondingly illustrated by linear shading which slopes up to the left, the character 3 is hidden (“camouflage”). In this case, the background is formed by the key body 4.

By way of example, the first color of the character 2 may correspond to the color “red” and the second color of the character 3 may correspond to the color “blue”. If the key body, which is permeable to light of the first and second colors, is now illuminated with blue light, the blue character 3 is embedded into a background of matching color and thus becomes less prominent for the user, which means that it can no longer be seen as a separate character. By contrast, the red character 2 stands out from the blue background in a form which is clearly visible to the user.

FIG. 2 shows a schematic illustration of the second operating state. In contrast to the first operating state, the key body 4 is now illuminated with light of the first color, for example red. This hides the character 2, and the character 3 appears in a form which is clearly visible to the user.

The first and second operating states can be implemented by an illumination device, for example, which has a radiation-emitting component preferably with two semiconductor chips, one of which emits light of a first color and the other of which emits light of a second color.

FIG. 3 shows a schematic illustration of the third operating state. In the third operating state, both characters appear in a form which is clearly visible to the user. This operating state can be implemented when the illumination is with ambient light and/or light of mixed color or white light which is produced by the illumination device.

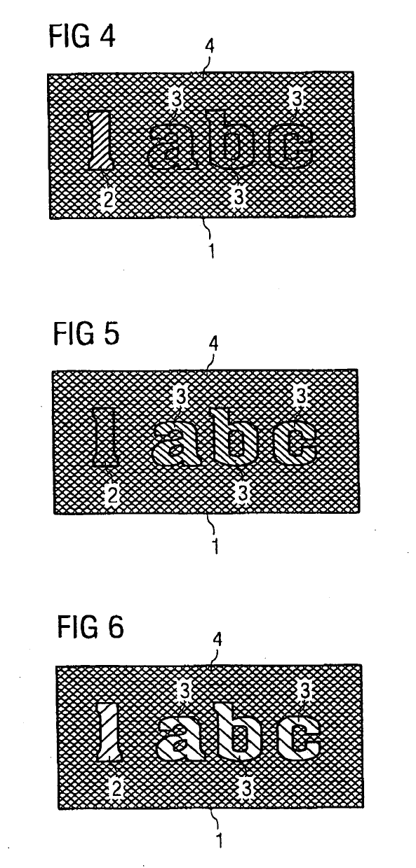

FIG. 4 shows a schematic illustration of the first operating state of the key 1 in line with a second exemplary embodiment of the invention. In this case, the character 2 is permeable to light of a first color, which is shown by linear shading which slopes up to the right. The character 3 is permeable to light of a second color, which is shown by linear shading which slopes up to the left. In addition, the character 2 is impermeable to light of the second color, while the character 3 is impermeable to light of the first color. The key body 4 is impermeable to light of the first and second colors, which is shown by a reticulate texture.

By way of example, the first color of the character 2 may correspond to the color “red” and the second color of the character 3 may correspond to the color “blue”. Accordingly, the reticulate texture of the key body symbolizes that the key body 4 is impermeable to red and blue light.

If the key body 4, which is impermeable to light of the first and second colors, is now illuminated with light of the first color, for example red, as shown in FIG. 4, both the key body 4 and the character 3, which is impermeable to light of the first color, block the light. The character 3 thus becomes less prominent and is no longer clearly visible to the observer. By contrast, the character 2 is permeable to light of the first color and is thus clearly visible to the user.

FIG. 5 shows a schematic illustration of the second operating state. In contrast to the first operating state, the key body 4 is now illuminated with light of the second color, for example blue. While the character 2 blocks the light of the second color, the character 3 allows the light of the second color to pass and thus appears in a form which is clearly visible to the user.

The first and second operating states can be implemented by an illumination device, for example, which has a radiation-emitting component with two semiconductor chips, one of which emits light of the first color and the other of which emits light of the second color.

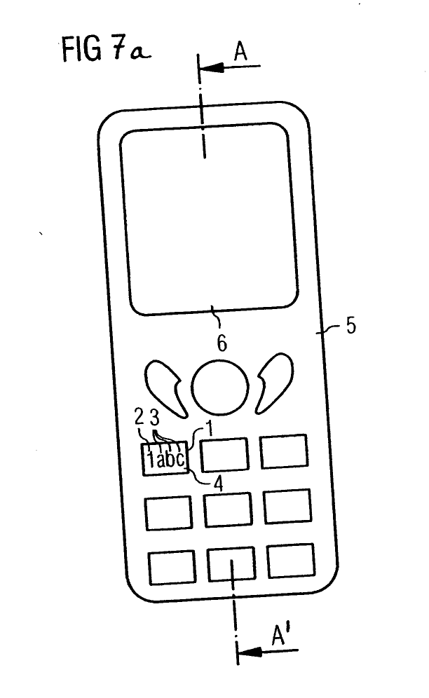

FIG. 6 shows a schematic illustration of the third operating state, where both characters appear in a form which is clearly visible to the user. This operating state can be implemented when the illumination is with ambient light and/or light of mixed color or white light which is produced by the illumination device.

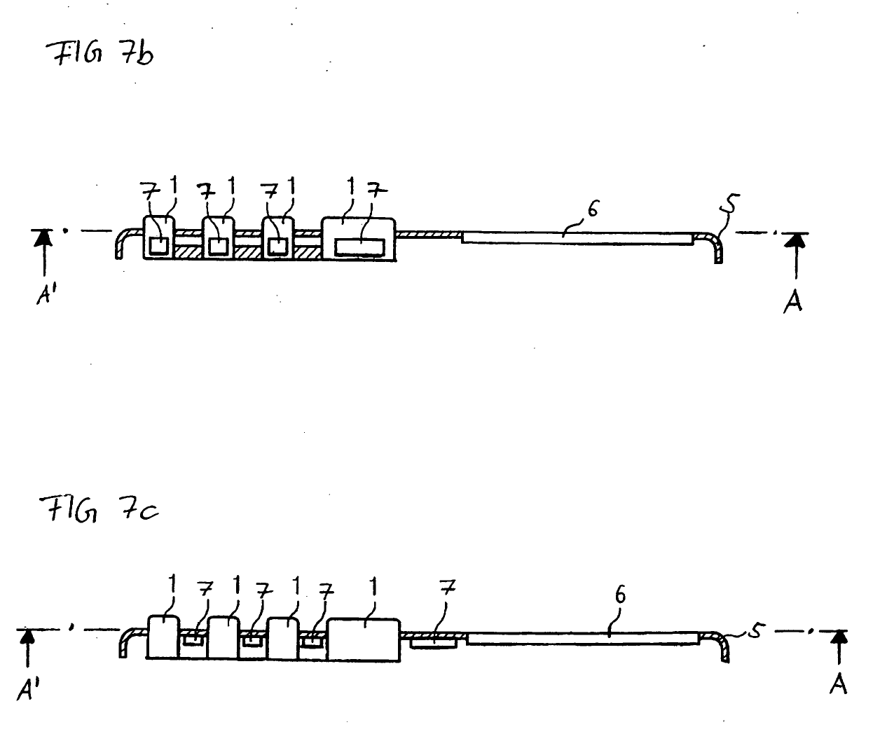

FIGS. 7a, 7b and 7c show a schematic illustration of a mobile telephone. It has a housing top part 5 and a display 6. The key 1 has contextual character display based on the invention. The mobile telephone shown in FIG. 7b has an illumination device integrated in the key 1. The key 1 is thus illuminated in a vertical direction relative to the housing top part. Alternatively, as shown in FIG. 7c, the key 1 can be illuminated laterally.

Advantageously, the invention uses no expensive components, such as LCD displays, to display the characters. In addition, already existing appliances can be equipped with the invention with comparatively little complexity.

The invention is not limited by the description with reference to the exemplary embodiments. Rather, the invention comprises any new feature and any combination of features, which includes any combination of features in the patent claims, in particular, even if this feature or this combination itself is not explicitly indicated in the patent claims or exemplary embodiments.

I claim:

1. An input device comprising:
a first character of a first color;
a second character of a second color; and
an illumination device which produces light of the first color and/or of the second color such that, depending on the illumination of the input device, in a first operating state only the first character of the first color appears and in a second operating state only the second character of the second color appears.

2. The input device as claimed in claim 1, wherein
the input device is a keypad, and wherein at least one key on the keypad has the first and the second character.

3. The input device as claimed in claim 2, wherein
in a third operating state the key is illuminated with light which contains the first and the second colors, so that both characters appear.

4. The input device as claimed in claim 2, wherein
the key has a key body made of a material which is permeable to light of the first and second colors, and is provided with the first character of the first color and with the second character of the second color.

5. The input device as claimed in claim 4, wherein
in the first operating state the first character can be seen when the key is illuminated with light of the second color.

6. The input device as claimed in claim 4, wherein
in the second operating state the second character can be seen when the key is illuminated with light of the first color.

7. The input device as claimed in claim 2, wherein
the key includes a material which is impermeable to light of the first and second colors, and is provided with the first character which is permeable to light of the first color and with the second character which is permeable to light of the second color.

8. The input device as claimed in claim 7, wherein
in the first operating state the first character can be seen when the key is illuminated with light of the first color.

9. The input device as claimed in claim 7, wherein
in the second operating state the second character can be seen when the key is illuminated with light of the second color.

10. The input device as claimed in claim 1, wherein
at least one character is preferably an alphanumeric symbol or an alphanumeric symbol sequence.

11. The input device as claimed in claim 1, wherein
the first character is a digit and the second character is a letter.

12. The input device as claimed in claim 1, wherein
the illumination device has at least one radiation-emitting semiconductor component.

13. The input device as claimed in claim 12, wherein
the radiation-emitting semiconductor component comprises a plurality of semiconductor chips.

14. The input device as claimed in claim 2, wherein
the light is injected into the key laterally from the illumination device.

15. The input device as claimed in claim 2, wherein
the light is injected into the key vertically from the illumination device.

16. The input device as claimed in claim 2, wherein
a common illumination device is provided for the keys on the keypad.

17. The input device as claimed in claim 16, wherein
the keys on the keypad are illuminated using an optical fiber.

18. The input device as claimed in claim 1, wherein
the input device is provided for a mobile electronic appliance, for example a mobile telephone, a Notebook, a PDA or an MP3 player.

19. The input device as claimed in claim 1, wherein
the color of the illumination can be set manually.

20. The input device as claimed in claim 1, wherein the color of the illumination is set automatically.
